(19) United States
(12) Patent Application Publication
(10) Pub. No.: US 2003/0119994 A1
(43) Pub. Date: Jun. 26, 2003

(54) Copolymers and compositions derived from neo vinyl esters, and processes of manufacture and use

(76) Inventors: Henry W. Yang, Kingwood, TX (US); James R. Hester, The Woodlands, TX (US)

Correspondence Address: ExxonMobil Chemical Company, P. O. Box 2149, Baytown, TX, 77522-2149, US

(21) Appl. No.: 10/212,838

(22) Filed: Aug. 6, 2002

Related U.S. Application Data
(60) Provisional application No. 60/313,253, filed on Aug. 17, 2001.

(51) Int. Cl. C08F 8/30; C08F 8/32

(52) U.S. Cl. 525/329.9; 525/330.5; 525/378; 525/380

(57) ABSTRACT

Copolymer prepared by polymerizing a branched neo vinyl ester component, an acidic component, and a component capable of providing a Tg of about −20° C. to 100° C. The copolymer can optimally be prepared in the presence of at least one surfactant. An amine neutralizing agent can be added to the copolymer.

### CROSS-REFERENCE TO RELATED APPLICATIONS

This application claims the benefit of priority of U.S. Provisional Application Serial No. 60/313,253, filed Aug. 17, 2001.

### FIELD OF THE INVENTION

This invention relates to copolymers and compositions prepared by polymerizing neo vinyl esters, especially branched neo vinyl esters, one or more agents to provide a desired Tg, one or more organic acids, such as acrylic acid and methacrylic acid, and an amine neutralizing agent capable of neutralizing the one or more organic acids. The present invention also relates to copolymers, to compositions including the copolymers, such as latex compositions and/or compositions including the copolymer and/or latex composition. Still further the present invention relates to processes of forming the neo vinyl ester copolymers and compositions, as well as to processes of using the neo vinyl ester copolymers and compositions. For example, the copolymer and compositions of the present invention can be utilized as adhesives and coatings, and are particularly suitable for metal coatings, especially for their ability to be corrosion resistant and to provide corrosion resistance to the coated material.

Discussion of Background Information

Organic coatings have been widely used as effective formulations to protect steel from corrosion. Depending on the binder/solvent makeup, coatings are generally classified into solvent-borne and water-borne categories. Recently, the use of water-borne coatings for the protection of steel has increased dramatically due to growing environmental pressure and demonstrated efficacy of waterborne coatings in metal protection. In the development of water-borne coatings, much effort has emphasized on the optimization of resins and coatings. formulation. Currently, water-borne resins widely used in the formulation of industrial coatings are styrene-acrylic latex polymers. However, styrene-acrylic latex polymers have yellowing characteristics that occur during exterior weathering.

Emulsion copolymers containing branched neo vinyl esters have been widely used in Europe and have recently gained prominence in North America due to their capabilities of providing water resistance, alkaline stability, superior coating performance, and low cost. These copolymers have found applications in architectural exterior and interior coatings. It has been reported that branched neo vinyl esters can react randomly with vinyl acetate and provide shielding to acetate groups from hydrolysis and alkali attack. The chains of the neo vinyl esters are believed to sterically hinder the approach of water and alkali molecules to the acetate group. An umbrella protection in the vicinity of the acetate groups improves their stability under rigorous environments. These monomers, when incorporated into the polymer backbone, provide additional hydrophobicity to the polymer leading to improved water resistance. Examples of neo vinyl ester copolymers can be seen in WO 94/14891, WO 99/42500 and WO 00/22016, which are incorporated by reference herein in their entireties.

Looney et al., U.S. Pat. No. 3,753,965 discloses ethylene-acrylic acid copolymers in particular form, such as, chips and rods that are surface treated with a base, such as alkali metal hydroxides or carbonates, ammonia or organic amines such as pyridine, alkyl amines or alkanol amines. In particular, Looney et al. disclose a treatment that affects only the surface of the polymer and does not significantly alter the original physical or chemical properties of the polymer as a whole. The base is disclosed to convert up to 2.5 percent of the total carboxyl groups to the corresponding salt to render the polymer less prone to blocking or sticking or bridging.

Olhoft et al., U.S. Pat. No. 3,766,116 discloses printing ink compositions containing alpha-olefin/alpha, beta-ethylenically unsaturated acid copolymer which is neutralized with an alkanolamine.

Hekal et al., U.S. Pat. No. 3,904,569 discloses metal coating compositions containing water dispersible carboxylic acid containing resin and aliphatic polyamine.

Smith, U.S. Pat. No. 5,777,071 discloses water reducible curing and sealing compounds for coating concrete substrates formed by combining a water soluble salt of an acrylic polymer resin with an alkanolamine. The compound can comprise a polymer resin that comprises a vinyl aromatic polymer, an acrylic ester or methacrylic ester, acrylic or methacrylic acid combined with an alkanolamine and water.

However, there is still a need for a coating composition for a substrate that is able to provide excellent corrosion resistance for the substrate over a period of time. Moreover, there is still a need for a coating composition that is highly adherable to a substrate and maintains the adherence over a period of time. Moreover, there is a need for coating compositions having high gloss, especially in combination with corrosion resistance and/or good substrate adherence.

### SUMMARY OF THE INVENTION

The present invention relates to copolymers and compositions containing the copolymers, such as latex compositions.

The present invention also relates to processes of forming the copolymers and compositions containing the copolymers.

Still further, the present invention relates to substrates at least partially coated, and preferred completely coated with the copolymers of the present invention.

Moreover, the present invention relates to compositions, such as paint compositions, containing the copolymers according to the present invention.

The present invention also relates to processes of coating substrates with compositions containing copolymers according to the present invention, including applying the compositions to a surface of a substrate, and permitting the composition to dry or drying the composition.

The present invention is directed to a composition comprising a copolymer prepared by polymerizing a branched neo vinyl ester component, an acidic component, and a component capable of providing a Tg of about −20° C. to 100° C., and an amine neutralizing agent.

The present invention is also directed to a copolymer prepared by polymerizing a branched neo vinyl ester component, an acidic component, and a component capable of providing a Tg of about −20° C. to 100° C. in the presence of at least one surfactant.

The present invention is also directed to a latex composition comprising (a) copolymer prepared by polymerizing a branched neo vinyl ester component, an acidic component, and a component capable of providing a Tg of about −20° C. to 100° C. in the presence of at least one surfactant in water, and (b) an amine neutralizing agent.

The branched neo vinyl ester component can comprise a mixture of neo vinyl esters of the following formula:

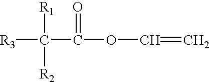

wherein R₁, R₂, and R₃ are independently hydrocarbyl groups, each independently having from 1 to 10 carbon atoms, with R₁+R₂+R₃ having a total average carbon atom content of from 3 to 25 carbon atoms. R₁, R₂, and R₃ can independently be alkyl groups, with R₁+R₂ +R₃ having a total average carbon content of from 6 to 14 carbon atoms, preferably 8 to 10 carbon atoms. Preferred total average carbon content of R₁+R₂ +R₃ is 8 or 10 carbon atoms.

The branched neo vinyl ester component can comprise a multi-isomer mixture of vinyl neo C9-C13 carboxylic acid esters containing at least 50 wt % vinyl neo C12 carboxylic acid ester.

The branched neo vinyl ester component can comprise a multi-isomer mixture of vinyl neo carboxylic acid esters containing at least 50 wt %.vinyl neo C10 carboxylic acid ester.

The acidic component can comprise at least one alpha or beta-ethylenically unsaturated carboxylic acid. The alpha or beta-ethylenically unsaturated carboxylic acid can comprise at least one of acrylic acid and methacrylic acid.

The component capable of providing a Tg of about −20° C. to 100° C. can comprise at least one acrylate compound.

The component capable of providing a Tg of about −20° C. to 100° C. can comprise at least one high Tg acrylate compound and/or at least one low Tg acrylate compound. The at least one high Tg acrylate compound can comprise at least one of methyl acrylate and methyl methacrylate. The at least one low Tg acrylate compound can comprise at least one of butyl acrylate, 2-ethylhexylacrylate and isooctyl acrylate.

The component capable of providing a Tg of about −20° C. to 100° C. can comprise at least two acrylate compounds, preferably methyl methacrylate and butyl acrylate.

The component capable of providing a Tg of about −20° C. to 100° C. can comprise a component capable of providing a Tg of about −20° C. to 40° C. Moreover, the component capable of providing a Tg of about −20° C. to 100° C. can comprise a component capable of providing a Tg of about 20° C. to 40° C.

The amine neutralizing agent can comprise at least one of ethanolamine, diethanolamine and ammonia, preferably ethanolamine.

The at least one surfactant can comprise at least one phosphate surfactant.

The copolymer can comprise, based upon total weight of copolymer, about 10 to 80 wt % of the branched neo vinyl ester component, about 0.5 to 5 wt % of the acidic component, up to about 90 wt % of the component capable of providing a copolymer Tg of about −20° C. to 100° C., and an amount of the amine neutralizing agent capable of neutralizing the acidic compound. The copolymer can also comprise, based upon total weight of copolymer about 30 to 60 wt % of the branched neo vinyl ester component, about 0.5 to 1.5 wt % of the acidic component, up to about 70 wt % of the component capable of providing a copolymer Tg of about −20° C. to 100° C., and at least about 0.5 wt % of the amine neutralizing agent capable of neutralizing the acidic compound.

The copolymer can comprise particles having a size of about 100 to 1,000 nm, preferably particles having a size of about 100 to 500 nm.

The present invention also relates to coating compositions, such as paint compositions, of the copolymers and latexes of the present invention.

The composition can further comprise sodium nitrite.

The present invention also relates to substrates at least partially coated with the copolymer and latexes of the present invention, such as substrates comprising at least one of metal, wood, nonwoven material, concrete, plastic and glass, preferably metal, such as steel.

### BRIEF DESCRIPTION OF THE DRAWING

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a water permeability test of coatings wherein change in grams is plotted over time.

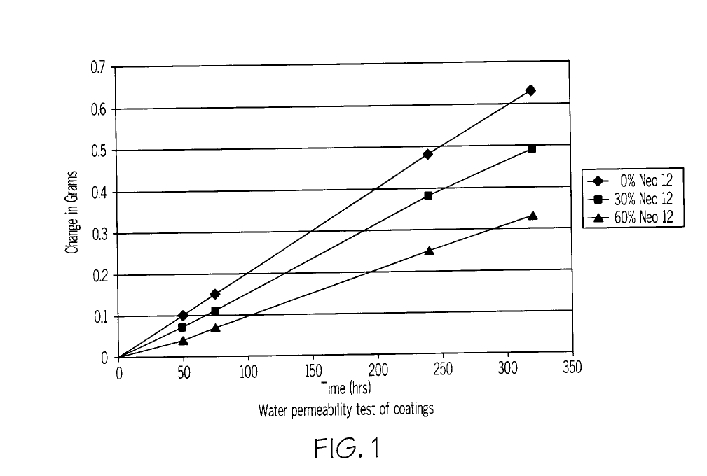

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of, the present invention in more detail than is necessary for the fundamental understanding of the present invention, the description taken with the drawings making apparent to those skilled in the art how the several forms of the present invention may be embodied in practice.

Unless otherwise stated, all percentages, parts, ratios, etc., are by weight.

Unless otherwise stated, a reference to a compound or component includes the compound or component by itself, as well as in combination with other compounds or components, such as mixtures of compounds.

Further, when an amount, concentration, or other value or parameter, is given as a list of upper preferable values and lower preferable values, this is to be understood as specifically disclosing all ranges formed from any pair of an upper preferred value and a lower preferred value, regardless whether ranges are separately disclosed.

The present invention is directed to compositions and copolymers containing and/or formed from a branched neo vinyl ester component, an acidic component, a component capable of providing a copolymer Tg of about −20° C. to 100° C., and at least one of an amine neutralizing agent and a surfactant, including, but not limited to, phosphate surfactant.

The branched neo vinyl ester component of the present invention are branched derivatives of neo acids (α, α, α-trisubstituted acetic acid). Thus, a vinyl neo carboxylic acid ester is a derivative of an acid having a neo structure, i.e., an acid having an α, α, α-trisubstituted carbon atom. The branched neo vinyl esters of the present invention are schematically represented as follows:

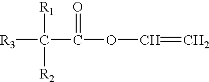

wherein R₁, R₂, and R₃ are independently hydrocarbyl groups, preferably alkyl groups, each independently having from 1 to 10 carbon atoms, with the sum of R₁+R₂+R₃ being from 3 to 25 carbon atoms, more preferably from 6 to 14 carbon atoms, and even more preferably 8-10 carbon atoms. As used herein, the term “hydrocarbyl” is understood to include “aliphatic,” “cycloaliphatic,” and “aromatic.” The hydrocarbyl groups are understood to include alkyl, alkenyl, alkynyl, cycloalkyl, aryl, arylalkyl, and alkaryl groups. Further, “hydrocarbyl” is understood to include branched and unbranched compounds, and both non-substituted hydrocarbyl groups, and substituted hydrocarbyl groups, with the latter referring to the hydrocarbon portion bearing additional substituents, besides carbon and hydrogen. Preferably, the hydrocarbyl groups are alkyl groups.

It is noted that the neo vinyl esters are usually present as a mixture of neo vinyl esters, including a multi-isomer mixture thereof. When the neo vinyl ester comprises a mixture of neo vinyl esters, the number of carbon atoms referred to is an average number of carbon numbers. Therefore, when a mixture is present, R₁+R₂+R₃ refers to the average number of the total of R₁+R₂+R₃ present in the mixture. In such an instance, the mixture will have a total average R₁+R₂+R₃ carbon atom content of 3 to 25. Such compounds are commonly referred to as vinyl neo C5 to C27 carboxylic acid esters. A number of neo vinyl esters are commercially available under the ExxonMobil Chemical trade name Exxar® Neo Vinyl Esters, and include compounds wherein R₁+R₂+R₃ include an average of 8 and 10 carbon atoms. For example, as disclosed in WO 99/42500, which is incorporated by reference herein in its entirety, the neo vinyl ester of the present invention can include a multi-isomer mixture of vinyl neo C9-C13 carboxylic acid esters containing at least 25 wt %, and preferably at least 50 wt % vinyl neo C12 carboxylic acid ester. Such neo vinyl ester can typically comprise vinyl neo C9 carboxylic acid ester (neo C9 vinyl ester), vinyl neo C10 carboxylic acid ester (neo C10 vinyl ester), vinyl neo C11 carboxylic acid ester (neo C11 vinyl ester), vinyl neo C12 carboxylic acid ester (vinyl C12 vinyl ester), and vinyl neo C13 carboxylic acid ester (neo C13 vinyl ester). Two preferred commercial neo vinyl esters are Exxar® Neo 10 Vinyl Ester and Exxar® Neo 12 Vinyl Ester sold by ExxonMobil Chemical, such as disclosed in WO 99/42500, which is incorporated by reference in its entirety.

The branched neo vinyl esters of the present invention can be prepared by any manner or technique, such as by a catalyzed reaction between a neo C9-C13 carboxylic acid mixture and acetylene or vinyl acetate. Processes for the synthesis of vinyl ester are well known and disclosed in U.S. Pat. Nos. 3,285,941, 3,455,998, 3,607,915 and 3,646,077, the disclosures of which are incorporated by reference herein in their entireties.

The acidic component of the present invention can comprise any organic acid that preferably improves the peel adhesion of the copolymers and compositions, such as formulated paints of the present invention (especially useful over metal surfaces) and/or maintains colloidal stability of compositions, such as formulated paints of the present invention.

The acidic component can comprise any organic acid, and preferably comprises alpha or beta-ethylenically unsaturated carboxylic acids, such as acrylic acid, methacrylic acid, crotonic acid, itaconic acid, formic acid, maleic acid, malic acid, and most preferably comprises acrylic acid and/or methacrylic acid.

The component capable of providing a copolymer Tg of about −20° C. to 100° C. can comprise one or more compounds that provide the desired Tg. Thus, if the desired Tg can be obtained by the use of one compound, then a single compound can be utilized. However, a combination of two or more compounds can be used to obtained the desired Tg. For example, the desired Tg can be obtained by utilizing two or more compounds in instances where one compound alone cannot achieve the desired Tg. However, even if one compound alone can achieve the desired Tg, it still may be beneficial to include two or more compounds to obtain the desired Tg, such as for matters of cost. For example, at the present time the cost of butyl acrylate is approximately about 20% less than the cost of methyl methacrylate.

The component capable of providing a copolymer Tg of about −20° C. to 100° C. preferably comprises vinyl acetate and (meth)acrylate compounds, such as alkyl (meth)acrylates, including high Tg (meth)acrylates and low Tg (meth)acrylates. In particular, according to the instant invention, the term high Tg (meth)acrylates is utilized with reference to (meth)acrylate compounds that have a Tg of 0° C. and higher, and the term low Tg (meth)acrylates is utilized with reference to (meth)acrylate compounds that have a Tg of less than 0° C. Depending upon the desired copolymer Tg, either a high Tg (meth)acrylate or a low Tg (meth)acrylate, or mixtures of one or more high Tg (meth)acrylates with one or more low Tg (meth)acrylates can be utilized. It is further noted that the term “(meth)acrylate” in the context of the present invention refers to both acrylate and methacrylate derivatives.

Examples of high Tg (meth)acrylates include methyl methacrylate and methyl acrylate, with methyl methacrylate being preferred. Examples of low Tg (meth)acrylates include ethyl acrylate, butyl acrylate, 2-ethylhexylacrylate, isooctyl acrylate, with butyl acrylate being preferred. Thus, mixtures of methyl methacrylate and butyl acrylate can be utilized, such as mixtures wherein the methylmethacrylate and butyl acrylate are present in a weight percentage of about 0 to 90, preferably about 10 to 50, and even more preferably about 15 to 40 weight percent butyl acrylate in the mixture of methyl methacrylate and butyl acrylate.

The component capable of providing a copolymer Tg of about −20° C. to 100° C. preferably provides a copolymer Tg of about −20° C. to 40° C. In the case of the use of the copolymer of the instant invention as an adhesive, the copolymer Tg can be as low as −20° C., and in the case of the use of the copolymer of the instant invention as a coating, such as a coating for metals, the copolymer Tg is preferably about 20° C. to 40° C.

The amine neutralizing agent can comprise any amine containing agent capable of neutralizing the acidic component. For example, the amine neutralizing agent can be organic amines, such as a primary amine, such as methylamine; secondary amines such as dimethyl amine; or tertiary amines, such as trimethyl amine. Examples of amine neutralizing agents according to the present invention include, but are not limited to pyridine, alkylamines and alkanolamines, such a methylamine, trimethyl amine, ethylamine, diethylamine, triethylamine, propylamine, tripropylamine, butylamine, diisobutylamine, N-methylbutylamine, N-ethylcyclohexylamine, ethyleneamine, diethylenetriamine, 2-propylenediamine, 1,3-diaminopropane, N,N-dimethylethanolamine, N-methylethanolamine, N-aminoethylethanolamine and diisopropanolamine. Preferred amine neutralizing agents include, but are not limited to alkanolamines containing up to six carbons, such as ethanolamine, and dimethylethanolamine, and ammonia. Moreover, additional additives can be included, such as, but not limited to, flash rust agents, such as sodium nitrite. In this regard, ethanolamine improves flash rust corrosion. Still, further flash rust agents, such as sodium nitrite can be included in the compositions, such as paint compositions.

Generally, the latexes and copolymers of the present invention can be formed by reaction of the components, including monomers and any other additives by emulsion polymerization which is a type of polymerization well known to the practitioners in the art. The reaction mixture generally includes monomer, surfactant and initiator. The initiator may be any compound(s) or source for generating free radicals capable of initiating polymerization of the acrylic monomers, such as, for example, azo compounds, persulfates, redox couples and the like. The amine neutralizing agent may be added after formation of the copolymer.

Once the reaction is complete, the solids, in the form of a dispersed latex, are allowed to cool to room temperature and the dispersed latex is usually separated from coagulum formed during polymerization by filtration. The dispersed latex may be coated directly onto a substrate film or may be incorporated into a paint or coating formulation that is applied to a substrate film. Suitable substrates include metal, glass, plastic, paper, cloth, wood, pressed wood, polymer film, woven fabric, nonwoven fabric, polyolefin, materials and the like. Examples of metallic substrates, such as for direct to metal application of compositions of the invention, include, but are not limited to, aluminum, copper, iron and steel, while examples of the plastic substrates include, but are not limited to, polyesters, polyolefins, and polyethylene terephthlate.

The copolymers and compositions of the present invention are extremely useful in preventing corrosion of surfaces of substrates in that the copolymer provides corrosion protection even at extremely small thicknesses of coatings containing the copolymers of the present invention. In this regard, the copolymer and latexes of the present invention can be utilized in various coating thicknesses while providing useful corrosion resistance. For example, the coating of the present invention can have a dry thickness of less than or equal to about 4 mils, can be less than or equal to about 2.3 mils, can be less than or equal to about 2 mils, and even be less than or equal to about 1.8 mils and still maintaining corrosion resistance.

Moreover, solution polymerization can be utilized to form copolymers of the present invention. In this case, the components, including monomers, involved are first dissolved in a common solvent, such as, but not limited to toluene, xylene, tetrahydrofuran (THF) and/or methylethylketone (MEK). A solvent-soluble initiator, such as a peroxide initiator, such as azo peroxide, is used to activate the polymerization preferably at temperatures of about 30° C. to 125° C. The amine neutralizing agent may be added after formation of the copolymer.

Varying amounts of other free radical polymerizable monomers can be employed in the present copolymer including acrylonitrile, vinyl acetate, vinyl chloride, vinylidene chloride, styrene, methyl styrene, and the like. It should be noted that some commercially available acrylic monomers or monomer mixtures also include minor amounts of acrylonitrile, styrene, vinyl acetate, and the like.

The characteristics of the latexes and copolymers of the present invention are affected by the surfactants utilized in their synthesis. The surfactants utilized are preferably phosphate and sulfonate surfactants, and most preferably phosphate surfactants, such as aliphatic phosphate esters. Examples of phosphate surfactants include, but are not limited to Rhodafac® RS-410 (aliphatic phosphate ester with 3 moles of EO), Rhodafac® RS-610 (aliphatic phosphate ester with 6 moles of EO), Rhodafac® RS-710 (aliphatic phosphate ester with 10 moles of EO), Rhodafac® RS-960 (aliphatic phosphate ester with 50 moles EO), and Rhodafac® PE 510 (aromatic phosphate ester with 6 moles of EO). Examples of sulfate surfactants include, but are not limited to, Rhodapex® C0436 (sulfated polyethoxynonylphenol), Rhodacal® 246 L (sodium alpha-olefin C14, C16 sulfonate), and Aerosol® OT (sodium dioctyl sulfosuccinate). Rhodafac®, Rhodapex®), and Rhodacal® are available from Rhodia, Cranbury, N.J., and Aerosol® OT is available from Cytec Industries Inc., W. Paterson N.J.

Moreover, it has been found that the stability of latexes according to the present invention is dependent upon the hydrophobicity of surfactants. Among five anionic Rhodia phosphate esters, a large amount of coagulum was formed when Rhodafac® RS-410 (more oil-soluble) and Rhodafac® RS-960 (more water-soluble) were used. Therefore, oil-soluble or water-soluble surfactants are less preferably used in the polymerization of the present invention. Rhodafac® RS-710, Rhodapex® C0436, Rhodacal® 246-L, and Aerosol® OT are especially preferred for providing coagulum free latex polymers containing neo vinyl esters for metal coatings applications. Without wishing to be bound by theory, these surfactants have a well balanced hydrophobicity and hydrophilicity.

Still further, it appears that aliphatic surfactants, especially aliphatic phosphate surfactants provide better adhesion and corrosion resistance than aromatic surfactants. Thus, compared with aromatic Rhodafac® PE-510, aliphatic Rhodafac® RS-610 provides better adhesion and corrosion protection even though they have the same Ethylene Oxide (EO) numbers.

The copolymers and compositions of the present invention preferably contain about 10 wt % to 80 wt % based upon total copolymer weight, more preferably about 30 wt % to 60 wt %, of neo vinyl esters; about 0.5 wt % to 5 wt %, more preferably 0.5 wt % to 1.5 wt %, with one preferred value being 1 wt %, of acidic component; and up to about 90 wt %, more preferably up to about 70 wt %, and even more preferably up to about 40 wt %, of the component capable of providing a copolymer Tg of about −20° C. to 100° C. An amount of amine neutralizing agent preferably capable of neutralizing the acidic compound, such as at least about 0.5 phr (one part per hundred parts resin), with preferred ranges being about 0.5 phr to 2.5 phr, more preferably about 1 phr to 2 phr of the amine neutralizing agent, with one preferred value being about 1.5 phr can be added to the copolymers and compositions of the present invention. As discussed above, the component capable of providing a copolymer Tg of about −20° C. to 100° C. can comprise a mixture of components, and preferably comprises about 30 wt % to 60 wt % of methyl methacrylate, and about 5 wt % to 40 wt % of butyl acrylate. Preferred neo vinyl ester copolymers according to the present invention, especially for metal coating applications, comprise 30 wt % to 60 wt % neo vinyl ester, preferably Exxar®t Neo 12, 30 wt % to 60 wt % methyl methacrylate, 5 wt % to 25 wt % butyl acrylate, and 0.5 to 1.5 wt % acrylic acid, and contains 1 to 2 phr amine neutralizing agent, preferably ethanolamine. For example, the neo vinyl ester copolymer according to the present invention can comprise 30 wt % Exxar® Neo 12, 53.5 wt % methyl methacrylate, 15.5 wt % butyl acrylate, and 1 wt % acrylic acid, and can contain 1.5 phr ethanolamine.

The latexes of the present invention comprise copolymer particles of the invention suspended in water, and include a surfactant to stabilize the latex composition. The latexes of the present invention can include various amounts of copolymeric particles, and preferably comprise about 30 to 75 wt % of copolymer particles per total weight of the latex composition, more preferably 40 to 70 wt %, more preferably about 50 to 70 wt % of copolymer particles, and even more preferably about 55 to 70 wt % of copolymer particles. The amount of surfactant, preferably at least one phosphate surfactant, in the latex is preferably about 0.5 to about 4 wt %, more preferably about 0.7 to about 3 wt %.

In general, it is noted that the water uptake of copolymer films and formulated compositions, such as formulated paints, decreases with increasing neo vinyl ester content in the latex copolymer. Moreover, it is noted that the gloss of coatings improves with increasing concentrations of neo vinyl ester in the copolymer. Still further, in general, it is noted that adhesion and performance of formulations, such as paint formulations, are improved by increasing the content of neo vinyl esters in the latex copolymers contained therein.

The copolymer particles preferably have a size of about 50 to 2,000 nm, more preferably about 100 to 1,000 nm, and even more preferably about 100 to 500 nm.

In order to more clearly describe the present invention, the following non-limiting examples are provided for the purpose of representation, and are not to be construed as limiting the scope of the invention. All parts and percentages in the examples are by weight unless indicated otherwise.

### EXAMPLES

Characterization of the copolymers and compositions of the present invention are defined utilizing the following:

I. Latex Characterization

A. Particle size

Particle size of the latexes was measured using a Coulter N4MD sub-micron particle size analyzer (available from Coulter Electronics Incorporated, Miami, Fla.).

B. Glass Transition Temperature

The glass transition temperature of latex polymers were measured by Mettler 821 DSC. The inflection points of DSC curves were recorded as the Tg values of the corresponding latex polymers.

II. Water Uptake Measurements

In the water absorption test, 10 phr TexanolTM (cosolvent) and 0.1 wt % Rohm & Haas AcrysolTM RM-825 (thickener) are blended with latexes to obtain continuous latex films. The blends are shaken well on a vortex shaker, and 6 mils of wet film are prepared using a draw down bar on polypropylene panels. Then, the films are dried at room temperature for a week. The obtained dried films are cut into about 6 cm×1 cm specimens, weighed and soaked in 100 mL of deionized water for 7 days. The soaked films are then removed from water, patted dry with a lint free filter paper and weighed. The weight of water absorbed is reported as the percentage of weight gain. Each sample weight gain data is based on the average of six measurements.

III. Adhesion

This property is tested by a cut tape test and pull-off adhesion test according to ASTM D 3359-90 and ASTM D4541-85, respectively.

IV. Corrosion Resistance of Coatings

The corrosion of metals tested in the present example is the oxidation of iron. The coatings introduce a protective layer between the substrate and environment and protect the metal from corrosion by the inhibition of diffusion of reactants, oxygen, and humidity. Basically, adhesion and permeability are important features for a coating to provide good corrosion protection. A coating has difficulty in providing adequate corrosion protection if it cannot contact the substrate tightly or has poor adhesion. If adhesion is lost, osmotic pressure may build up and furthermore blistering may occur. To evaluate the corrosion resistance of coatings derived from neo vinyl ester copolymers, e.g., Exxar® Neo 12 Vinyl Ester sold by ExxonMobil Chemical, a salt fog test is performed according to ASTM B 117-90. Panels for corrosion testing are prepared by applying derived paints onto Q cold-rolled steel panels (S-36) with a drawdown bar. Dried panels are scribed with an “X” in a lower part the panel to evaluate failure at the scribed area. Panels used for salt fog test are evaluated in the following three parameters according to the ASTM standards indicated below.

A. Degree of Rusting

This test covers evaluation of the degree of rusting on painted steel surfaces using visual standards (ASTM D610-85). It is scaled into 11 grades from 0 (100% of surface rusted) to 10 (no rusting).

B. Degree of Blistering

This test evaluates the size and density of blisters on painted surface (ASTM D 714). The size is numerically scaled from 0 (largest) to 10 (no blistering); the frequency of blisters is designated as dense (D), medium dense (MD), medium (M), and few (F).

C. Evaluation of Scribed Area

This method provides a technique of evaluating and comparing corrosion performance of coated specimens with respect to corrosion and loss of adhesion at the scribe mark (ASTM D 1654-92). The creepage at the scribe is rated from 10 (zero creepage) to 0 (over 16 mm creepage).

### Examples 1

### Preparation of Surfactant Stabilized Latex Formulations

A. Synthesis of Latex Copolymers

Emulsion polymerization was carried out in a latex reactor system, including a 1 liter cylindrical kettle equipped with a nitrogen purge, condenser, and metallic stirrer. A Camile 2000 automated monomer feeding assembly (available from Argonaut Technologies Systems, Indianapolis, Indiana) was used to control, monitor, and record monomer feeding rates and reaction temperatures.

Surfactant stabilized latex formulations were prepared utilizing the components denoted in Table 1.

TABLE 1
Latex formulation of Neo 12 latexes

| | | | |
|---|---|---|---|
| | Weight (grams) | Weight (grams) | Weight (grams) |
| Ingredients | Copolymer 1 | Copolymer 2 | Copolymer 3 |

Reactor charge

| | | | |
|---|---|---|---|
| Water | 166 | 166 | 166 |
| Surfactant | 6.8 | 6.8 | 6.8 |
| (25%) | | | |

Pre-emulsion

| | | | |
|---|---|---|---|
| Water | 205 | 205 | 205 |
| Surfactant | 6.8 | 6.8 | 6.8 |
| (25%) | | | |
| Neo 12 | 0 | 100.8 | 201.60 |
| Methyl | 199.92 | 153.22 | 107.86 |
| methacrylate | | | |
| Butyl acrylate | 132.72 | 78.62 | 23.18 |
| Acrylic acid | 3.36 | 3.36 | 3.36 |

Initiator

| | | | |
|---|---|---|---|
| Water | 50 | 50 | 50 |
| (NH₄)₂S₂O₈ | 1.67 | 1.67 | 1.67 |

Chaser Solution

| | | | |
|---|---|---|---|
| Water and tert- | 5; 0.15 | 5; 0.15 | 5; 0.15 |
| Butyl | | | |
| Hydroperoxide | | | |
| (BHP) | | | |
| Water and | 5; 0.1 | 5; 0.1 | 5; 0.1 |
| Sodium | | | |
| formaldehyde | | | |
| sulfoxylate | | | |

The kettle was charged with the reactor charge and initiator, and flushed with nitrogen for 30 minutes at 84° C. before feeding monomers. A pre-emulsion solution was prepared by mixing the surfactant, deionized water, and monomers with a stirrer at 1500 rpm for 15 minutes. In the polymerization, 10% of pre-emulsion solution, and 20% of the initiator solution were added to the kettle in that order for initial feeding. Temperature was maintained at 84±1° C. After 20 minutes, the remaining pre-emulsion and initiator solutions were fed through separate pumps to the reaction system. The addition time of pre-emulsion and initiator solution were 3 hours and 3.5 hours, respectively. After the initiator addition was complete, the chaser solution, i.e., water and BHP followed by water and sodium formaldehyde sulfoxylate, was separately added into the reactor within 30 minutes to further complete the polymerization of monomers. The reaction was then post reacted for 1.5 hours. After the reaction, the latex was cooled and filtered through a fine filter.

The following series of 1 parts per hundred parts resin (phr) surfactants were applied to the synthesis of neoacrylic latex polymers in order to study the effect of surfactants on the performance of latexes and their derived paints. The behavior and stability of latexes were studied by varying the surfactant as well as the chemical compositions of the latex copolymers, including copolymers with 0 wt %, 30 wt %, and 60 wt % Neo 12.

The surfactants included can be classified into sulfonate and phosphate categories. The phosphate surfactant includes Rhodafac® RS-410 (aliphatic phosphate ester with 3 moles of EO), Rhodafac® RS-610 (aliphatic phosphate ester with 6 moles of EO), Rhodafac® RS-710 (aliphatic phosphate ester with 10 moles of EO), Rhodafac® RS-960 (aliphatic phosphate ester with 50 moles EO), and Rhodafac® PE 510 (aromatic phosphate ester with 6 moles of EO). The sulfate surfactants include Rhodapex® CO436 (sulfated polyethoxynonylphenol), Rhodacal® 246 L (sodium alpha-olefin C14, C16 sulfonate), and Aerosol® OT (sodium dioctyl sulfosuccinate).

The chemical compositions of corresponding copolymers are given in Table 2. These copolymer latexes were synthesized with a designed glass transition temperature of 20° C. and 43.1% solids. Thus, Neo 12 copolymer latexes were synthesized according to the experimental procedure described above, with the chemical composition being given in Table 2, with MMA being methyl methacrylate, BA being butyl acrylate, and AA being acrylic acid.

TABLE 2
Chemical compositions of latex copolymers
used as coatings binder

| | Neo 12 | MMA | | |
|---|---|---|---|---|
| Copolymers | (wt %) | (wt %) | BA (wt %) | AA (wt %) |
| 1 | 0 | 59.5 | 39.5 | 1 |
| 2 | 30 | 45.6 | 23.4 | 1 |
| 3 | 60 | 32.1 | 6.9 | 1 |

Table 3 provides further information, including the surfactant utilized in the preparation, the particle size of the copolymer in the latex, the percent conversion and the actual glass transition temperature of the obtained latexes which were used for the preparation of steel coatings.

TABLE 3
Information of latex copolymers for use as coatings binder

| Ex. | Surfactant | Neo 12 | Particle | Conversion | T_{g} |
|---|---|---|---|---|---|
| No. | (1 phr) | (wt %) | size (nm) | (wt %) | (° C.) |
| 1 | Rhodapex ® C0436 | 0 | 110 | 99.8 | 26.3 |
| 2 | Rhodafac ® 710 | 0 | 118 | 99.6 | 24.2 |
| 3 | Rhodafac ® 710 | 30 | 145 | 99.5 | 24.1 |
| 4 | Rhodafac ® 710 | 60 | 133 | 99.6 | 25.4 |
| 5 | Aerosol ® OT | 30 | 117 | 98.6 | 26.5 |
| 6 | Aerosol ® OT | 60 | 107 | 99.1 | 25.9 |
| 7 | Rhodapex ® C0436 | 30 | 118 | 99.0 | 24.8 |
| 8 | Rhodapex ® C0436 | 60 | 103 | 100 | 23.9 |
| 9 | Rhodacal ® A246L | 30 | 110 | 99.7 | 24.5 |
| 10 | Rhodacal ® A246L | 60 | 110 | 99.5 | 23.1 |

Depending on the surfactants used in the polymerization, the diameters particles varied from 103 nm to 145 nm. The reaction conversion was 100%, which means that the proposed emulsion polymerization methods able for the synthesis of neo vinyl ester latex polymers, such as the illustrated Neo 12 vinyl ester copolymers in Table 3. The copolymer Tg values were measured by DSC and also listed in Table 3.

Based on the experimental observation, Rhodafac® RS-710 is a preferred surfactant. Additionally, coagulum free latexes were also obtained from Rhodapex® CO436, Rhodacal® 246 L, and Aerosol® OT.

Rhodafac® RS-710, Rhodapex® CO436, Rhodacal® 246-L, and Aerosol® OT provided coagulum free latex copolymers containing neo vinyl esters for metal coatings applications.

Water Absorption of Latex Copolymers

Table 4 shows the water uptake information of latexes listed in Table 3. The water uptake is obtained from an average of six samples. It shows that the water uptake of copolymer films decreases with the addition of neo vinyl ester monomer, such as Neo 12, in all surfactant cases. This is believed to be attributable to the low polarity of the Neo 12 monomer.

It is noted that throughout the examples similar formulations are designated with the same Example No., and further experiments with these formulations will be referred to by increasing alphabetical designations, such as Examples Nos. 12, 12A, 12B, etc.

TABLE 4
Water uptake information of latex copolymers

| Example | Surfactant | Neo 12 | Water Uptake |
|---|---|---|---|
| No. | (1 wt %) | (%) | (±1%) |
| 1A | Rhodapex ® C0436 | 0 | 53 |
| 2A | Rhodafac ® 710 | 0 | 42 |
| 3A | Rhodafac ® 710 | 30 | 36 |
| 4A | Rhodafac ® 710 | 60 | 32 |
| 5A | Aerosol ® OT | 30 | 62 |
| 6A | Aerosol ® OT | 60 | 27 |
| 7A | Rhodapex ® C0436 | 30 | 23 |
| 8A | Rhodapex ® C0436 | 60 | 20 |
| 9A | Rhodacal ® A246L | 30 | 35 |
| 10A | Rhodacal ® A246L | 60 | 19 |

Properties Of Coatings Derived From Neo Vinyl Ester Copolymers

Latex copolymers derived from neo vinyl esters, such as Neo 12, were formulated into metal coatings. Their performance in the areas of gloss, water vapor transmission and corrosion resistance were evaluated.

The most common substrate in industrial maintenance is steel. Q cold-rolled steel panels were used as being representative steel. Panels for corrosion testing were prepared by applying the paints on Q cold-rolled steel panels (S-36).

A. Properties Derived From High Gloss White Formulation A

All copolymers given in Table 4 were used to formulate into white topcoats according to the paint formulation and in the order of preparation given in Table 5 below.

TABLE 5
High Gloss Formulation A

| Ingredients | Parts |
|---|---|
| Water | 5.33 |
| Surfynol 210 | 0.02 |
| Natrosol 250 HBR | 0.03 |
| Mix 5-10 min. | |
| Ammonia (28%) | 0.01 |
| Mix 10-15 min. | |
| Surfynol 104 DPM | 0.48 |
| BYK 155 | 0.21 |
| Ti Pure R-1076 | 21.33 |

Disperse to 7 Hegman gauge, then add

| | |
|---|---|
| Latex (from TABLE 3) | 63.02 |
| Surfynol 210 | 0.48 |
| Surfynol 104 DPM | 1.45 |
| Ammonia (28%) | 0.19 |
| Eastman EB | 2.9 |
| Eastman DP | 0.72 |
| Sodium nitrite (10%) | 0.61 |

Premix then add

| | |
|---|---|
| Water | 2.98 |
| Acrysol RM-8-W | 0.24 |
| Total | 100.00 |

Note: Above table is based on 20% pigment volume concentration (PVC) formulation

In Table 5, Surfynol 210 and Surfynol 104 DPM were obtained from Air Productsand Chemicals, Allentown, Pa.; Natrosol 250 HBR was obtained from Hercules Incorporated, Wilmington, Del.; Ammonia and Sodium Nitrite (10%) were obtained from Aldrich, Milwaukee, Wis.; BYK 155 was obtained from BYK Chemie, Walinford, Conn.; TiPure R-1076 was obtained from Dupont, Wilmington, Del.; Eastman EB and Eastman DP were obtained from Eastman Chemical, Kingsport, Tenn.; and Acrysol RM-8-W was obtained from Rohm & Haas, Philadelphia, Pa.

The paint panels were prepared by applying 8 mils of wet paint on Q cold-rolled steel panels (S-36) using a drawn down bar. The thickness of the dried paint films is about 2±0.2 mils.

The gloss of the white topcoats using the latex copolymers of Table 3 is Table 6 below.

TABLE 6
Gloss information of coatings

| Example | | Neo 12 | Gloss of pigmented films | | |
|---|---|---|---|---|---|
| No. | Surfactants | (%) | 20° | 60° | 85° |
| 11 | Rhodapex ® C0436 | 0 | 14.2 | 54.8 | 76.9 |
| 12 | Rhodafac ® RS-710 | 0 | 19.0 | 58.0 | 81.7 |
| 13 | Rhodafac ® RS-710 | 30 | 32.1 | 72.1 | 91.8 |
| 14 | Rhodafac ® RS-710 | 60 | 36.5 | 74.6 | 91.2 |
| 15 | Aerosol ® OT | 30 | 23.1 | 68.3 | 89.3 |
| 16 | Aerosol ® OT | 60 | 24.5 | 69.8 | 91.5 |
| 17 | Rhodapex ® CO436 | 30 | 22.6 | 66.9 | 91.1 |
| 18 | Rhodapex ® CO436 | 60 | 26.5 | 69.8 | 91.8 |
| 19 | Rhodacal ® A-246L | 30 | 19.5 | 62.9 | 92.8 |
| 20 | Rhodacal ® A-246L | 60 | 30.1 | 70.5 | 91.8 |

Table 6 shows that the gloss of the paints was improved by the addition of neo vinyl ester, such as Neo 12, in all three degrees.

Adhesion analysis of coatings on the metal panels was performed by cut tape test and pull-off adhesion test according to ASTM D 3359-90 and ASTM D4541-85, respectively, with the results of testing of the panels in Table 6 after one week of ambient drying being shown in Table 7.

TABLE 7
Adhesion of pigmented films on steel panels
by tape test (One week ambient drying)

| Example | | Code on | Neo 12 | |
|---|---|---|---|---|
| No. | Surfactants | panels | (%) | Adhesion |
| 11A | Rhodapex ® C0436 | 9 | 0 | 5B |
| 12A | Rhodafac ® 710 | 10 | 0 | 1B |
| 13A | Rhodafac ® 710 | 1 | 30 | 4B |
| 14A | Rhodafac ® 710 | 2 | 60 | 4B |
| 15A | Aerosol ® OT | 3 | 30 | 5B |
| 16A | Aerosol ® OT | 4 | 60 | 5B |
| 17A | Rhodapex ® C0436 | 5 | 30 | 5B |
| 18A | Rhodapex ® C0436 | 6 | 60 | 5B |
| 19A | Rhodacal ® A246L | 7 | 30 | 5B |
| 20A | Rhodacal ® A246L | 8 | 60 | 5B |

For cut tape test, it was found that after a week of ambient aging, Rhodafac® RS-710 led to low adhesion, compared with other surfactant latexes. However, it should be noted that neo vinyl ester monomer, such as Neo 12, improved the adhesion of paints from 1B to 4B by increasing the content of neo vinyl ester monomer from 0% to 30% or 60%. The adhesion of paints was evaluated again after one month of ambient aging, it was found that all the paints reached 5B in adhesion.

Pull-off adhesion test was performed in order to further study the adhesion difference of coatings over metal. The obtained results using latex panels of Table 6 are shown in Table 8.

TABLE 8
Pull-off test results of paints over steel
panels (Averaged data of four samples)

| | | | Break stress |
|---|---|---|---|
| Example No. | Paints | | (Psi) |
| 12B | Rhodafac ® RS-710 | 0% Neo 12 | 200 |
| 13B | | 30% Neo 12 | 225 |
| 14B | | 60% Neo 12 | 250 |

The break stress data shows that after one month of aging of the panels in Table 6 the adhesion of all paints related to Rhodafac® RS-710 improved with increasing amount of Neo 12.

The salt fog test was performed according to ASTM B 117-90. To study the effect of pretreatment of Q panels on the effect of rusting, panels cleaned with and without acetone were evaluated and compared. After coating and drying with paint samples containing Rhodafac® RS-710 as utilized in Table 8, panels were scribed a “X” in the low part of the panel to evaluate failure at the scribe. Two panels were tested in the salt fog chamber for each sample. The grading of performance of coatings after 500 hours in salt fog chamber is given in Table 9.

TABLE 9
Evaluation of pigmented films on steel
panel (500 hour salt spray test)

| | | | Blister | Blister | Rusting | Failure |
|---|---|---|---|---|---|---|
| Example No. | Panels | | size | frequency | degree | at scribe |
| 12C | 0% | Neo12 | 7 | D | 3 | 7 |
| 12D | T-0% | Neo12* | 7 | D | 3 | 6 |
| 13C | 30% | Neo12 | 5 | M | 7 | 7 |
| 13D | T-30% | Neo12 | 7 | M | 5 | 6 |
| 14C | 60% | Neo12 | 8 | M | 8 | 7 |
| 14D | T-60% | Neo12 | 7 | M | 5 | 7 |

*T notes that panels were cleaned by acetone

Among latexes synthesized with surfactants Rhodafac® RS-710, Rhodapex® CO436, Rhodacal® 246 L, and Aerosol® OT, phosphate Rhodafac® RS-710 outperformed sulfate surfactants (Rhodapex® CO436 and Rhodacal® 246 L) and sulfonate surfactants (Aerosol® OT) in the protection of steel panels from rusting. Paints made of latexes with sulfate and sulfonate surfactants failed after 250 hours of salt spay test. The advantage of phosphate in latex could be attributed to the phosphate coatings, which may be formed on the surface of metal panels. Phosphate coatings are used in the industry to prevent corrosion of metal. Without being wished to be bound by theory, it coats and blocks the active center on the steel to prevent corrosive elements from attacking the metal. Additionally, phosphate coatings also provide retained adhesion. Additionally, the paint finishes over phosphates coatings demonstrate strong adhesion over prolonged periods of time.

Neo vinyl esters, such as Neo 12, have strong effect on the performance of paints. Neo vinyl esters, such as Neo 12, in the latex help to inhibit the corrosion of paint panels, compared with the panel coated with 0% Neo 12 latex paints. The density and size of blistering, and the rusting area is reduced after the incorporation of the neo vinyl ester, such as Neo 12, into the latexes. The permeability of coatings significantly decreased with increasing content of the neo vinyl ester.

Panels without pretreatment performed slightly better than the panels pretreated by acetone.

B. Properties Derived From High Gloss Formulation B

Similar latex compositions to High Gloss Formulation A, shown in Table 5, were used in the preparation of High Gloss Formulation B given in the order of preparation of Table 10 as follows.

TABLE 10
High Gloss Formulation B

| Ingredients | Parts |
|---|---|
| Water | 40 |
| DPM (Coalescent) | 18 |
| Tamol 165 (Dispersant) | 9.5 |
| Triton CF-10 (Wetting agent) | 1.5 |
| Ammonia (28%) | 1 |
| Tego 1488 (Defoamer) | 1.5 |
| Ti Pure R-706 (Pigment) | 195 |
| Disperse to 7 Hegman gauge, then add | |
| Latex from Table 3 | 523 |
| Ammonia (28%) | 4 |
| DPnB | 55 |
| Water | 85 |
| Dibutyl phthalate (Plasticizer) | 14 |
| Tego 1488 | 2.5 |
| Sodium nitrite (15%) | 9 |
| Acrysol RM-8W (Thickener) | 3 |

PVC (%)=16

Volume solids (%)=37.1

VOC,g/L=181.7

In Table 10, DPM, Triton CF-10 and DPnB were obtained from Dow, Midland, Mich.; Tamol 165 and Acrysol RM-8-W was obtained from Rohm & Haas, Philadelphia, Pa.; Ammonia, Sodium Nitrite (10%) and Dibutyl phthalate were obtained from Aldrich, Milwaukee, Wis.; Tego 1488 was obtained from Tego Chemie, Hopewell, Va.; TiPure 1488 was obtained from Dupont, Wilmington, Del.; and Acrysol RM-8-W was obtained from Rohm & Haas, Philadelphia, Pa.

Previous study showed that Rhodafac® RS-710 latexes demonstrated much better corrosion resistance than other surfactant latexes. Therefore, neo vinyl ester latexes, such as including Neo 12, synthesized using Rhodafac® RS-710 were used for further improving the performance of neo vinyl ester latexes in the protection of steel. The effect of percentage of neo vinyl ester in copolymer, Tg, and flash rusting agents on the performance of coatings were further investigated.

(1) Effect of Neo Vinyl Ester Concentration

Similarly, 0%, 30%, and 60% Neo 12 copolymer latexes were used to investigate the effect of neo vinyl esters on the performance of coatings. The copolymer Tg values of these three latexes were designed to be 24° C. These latexes were synthesized with Rhodafac® RS-710 as listed in Table 3.

Table 11 demonstrates that 30% and 60% Neo 12 latexes worked much better than 0% Neo 12 paints. Table 11 also shows that the gloss of Neo 12 latex paints increases with increasing Neo 12 in the copolymer.

TABLE 11
Latex copolymers and performance for studying the effect
of Neo 12 on corrosion resistance (500 hours salt fog test,
samples synthesized with Rhodafac ® RS-710)

| | | | | Blistering | | |
|---|---|---|---|---|---|---|
| Ex. | Neo 12 | Gloss at 20, | Tg | Density and | Corrosion | Scribed |
| No. | (%) | 65 and 85° | (° C.) | size | area | area |
| 21 | 0 | 6; 46; 89 | 24.2 | MD,2 | 2 | 2 |
| 22 | 30 | 11; 56; 94 | 24.1 | MD,2 | 8 | 8 |
| 23 | 60 | 30; 74; 97 | 25.4 | M,2 | 10 | 9 |

The hydrophobicity of the neo vinyl ester latex paints was tested by measuring the contact angle of water drops on the surface of coatings. Table 12 shows that the contact angle increased from 65° to 75° after 30 or 60% Neo 12 was added in the copolymer. Increased contact angle indicates increased hydrophobicity.

TABLE 12
Contact angles of coating over metal substrate

| Example No. | Neo12/MMA/BA/AA | Tg (° C.) | Contact angle (°) |
|---|---|---|---|
| 21A | 0/59.5/39.95/1 | 24.2 | 65.2 |
| 22A | 30/45.6/23.4/1 | 24.1 | 75.5 |
| 23A | 60/32.1/6.9/1 | 25.4 | 75.8 |

(2) Effect of Tg on Corrosion Resistance

Tg of commercial latexes used in the industrial coatings is in the range of 24° C. to 40° C. Considering that harder copolymer binders provide better corrosion resistance due to their lower swelling and water uptake, a series of samples with various Tg values were prepared to study the effect of Tg of copolymers on the performance of neo vinyl ester latexes. The compositions of latex copolymers and performance are listed in Table 13 as follows:

TABLE 13
Latex copolymers and performance for studying the effect
of Tg on corrosion resistance (500 hours salt fog test)

| | | | Blistering | | |
|---|---|---|---|---|---|
| Example | | | Density and | | |
| No. | Neo12/MMA/BA/AA | Tg (° C.) | size | Corrosion area | Scribed area |
| 24 | 30/46.8/22.2/1 | 30.8 | MD,2 | 8 | 6 |
| 25 | 30/50.0/19.0/1 | 35.9 | MD,2 | 9 | 7 |
| 26 | 30/53.5/15.5/1 | 38.8 | F,2 | 10 | 9 |

Table 13 shows that the density of blistering, rusting area, and creepage in the scribed area decreased with the increasing Tg values of copolymers.

(3) The Effect of Amine Neutralizing Agent

In these experiments, ethanolamine was utilized as the amine neutralizing agent to study the effect on neo vinyl ester latex coatings. Additionally, sodium nitrite, which is an additive often utilized in paint latex coating formulations, was also utilized.

The use of ethanolamine to improve the metal corrosion resistance of latex copolymers is novel. One purpose of adding ethanolamine to the paint formulation in Table 14 is to neutralize the acrylic acid moiety incorporated in the latex copolymer. Based on the weight of acrylic acid moiety incorporated in the copolymer, four samples with various amount of ethanolamine were tested. The first three samples without sodium nitrite were added with 0 phr, 1 phr, and 1.5 phr ethanol amine, and the fourth sample contained both 1.5 phr ethanolamine and sodium nitrite, whose amount was given in Table 10. The performance of Example 26 paints with various amount of ethanolamine (EA) is summarized in Table 14. Ethanolamine did inhibit the corrosion of metal panels. Paints containing 1.5 phr ethanolamine only and 1.5 phr ethanolamine and sodium nitrite combination worked slightly better than the paint with 1 phr ethanolamine alone.

TABLE 14
The Effect of Amine Neutralizing Agent and Flash
Rusting Agents (500 hours salt fog test)

| | | Blistering | | |
|---|---|---|---|---|
| | | density and | | Scribed |
| Example No. | Tg (° C.) | area | Corrosion area | area |
| 26A, 0 phr EA | 38.8 | MD, 4 | 1 | 7 |
| 26B, 1 phr EA | | M, 1 | 8 | 6 |
| 26C, 1.5 phr EA | | MD, 2 | 8 | 6 |
| 26D, 1.5 phr EA | | MD, 2 | 9 | 7 |
| with NaNO₂ | | | | |

Although the invention has been described with reference to particular means, materials and embodiments, it is to be understood that the invention is not limited to the particulars disclosed, and extends to all equivalents within the scope of the claims.

We claim:

1. A composition comprising a copolymer prepared by polymerizing a branched neo vinyl ester component, an acidic component, and a component capable of providing a Tg of about −20° C. to 100° C., and an amine neutralizing agent.

2. The composition according to claim 1 wherein the branched neo vinyl ester component comprises a mixture of neo vinyl esters of the following formnula: 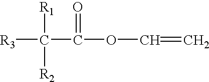
wherein R₁, R₂, and R₃ are independently hydrocarbyl groups, each independently having from 1 to 10 carbon atoms, with R₁ +R₂ +R₃ having a total average carbon atom content of from 3 to 25 carbon atoms.

3. The composition according to claim 2 wherein R₁, R₂, and R₃ are independently alkyl groups, with R₁+R₂+R₃ having a total average carbon content of from 6 to 14 carbon atoms.

4. The composition according to claim 3 wherein the total average carbon content of R₁+R₂+R₃ is from 8 to 10 carbon atoms.

5. The composition according to claim 4 wherein the total average carbon content of R₁+R₂+R₃ is 8 carbon atoms.

6. The composition according to claim 4 wherein the total average carbon content of R₁+R₂+R₃ is 10 carbon atoms.

7. The composition according to claim 2 wherein the branched neo vinyl ester component comprises a multi-isomer mixture of vinyl neo C₉-C₁₃ carboxylic acid esters containing at least 50 wt % vinyl neo C₁₂ carboxylic acid ester.

8. The composition according to claim 3, wherein the copolymer comprises about 10 to 80 wt % of neo vinyl ester component based upon total copolymer weight.

9. The composition according to claim 8, wherein the copolymer comprises about 30 to 60 wt % of the neo vinyl ester component based upon total copolymer weight.

10. The composition according to claim 3 wherein the acidic component comprises at least one alpha or beta-ethylenically unsaturated carboxylic acid.

11. The composition according to claim 10 wherein the alpha or beta-ethylenically unsaturated carboxylic acid comprises at least one of acrylic acid and methacrylic acid.

12. The composition according to claim 3 wherein the component capable of providing a Tg of about −20° C. to 100° C. comprises at least one acrylate compound.

13. The composition according to claim 12 wherein the component capable of providing a Tg of about −20° C. to 100° C. comprises at least two acrylate compounds.

14. The composition according to claim 13 wherein the component capable of providing a Tg of about −20° C. to 100° C. comprises methyl methacrylate and butyl acrylate.

15. The composition according to claim 13 wherein the component capable of providing a Tg of about −20° C. to 100° C. comprises at least one high Tg acrylate compound.

16. The composition according to claim 15 with the at least one high Tg acrylate compound comprises at least one of methyl acrylate and methyl methacrylate.

17. The composition according to claim 13 wherein the component capable of providing a Tg of about −20° C. to 100° C. comprises at least one low Tg acrylate compound.

18. The composition according to claim 17 wherein the at least one low Tg acrylate compound comprises at least one of butyl acrylate, 2-ethylhexylacrylate and isooctyl acrylate.

19. The composition according to claim 12 wherein the component capable of providing a Tg of about −20° C. to 100° C. comprises a component capable of providing a Tg of about −20° C. to 40° C.

20. The composition according to claim 12 wherein the component capable of providing a Tg of about −20° C. to 100° C. comprises a component capable of providing a Tg of about 20° C. to 40° C.

21. The composition according to claim 3 wherein the amine neutralizing agent comprises at least one of ethanolamine, diethanolamine and ammonia.

22. The composition according to claim 21 wherein the amine neutralizing agent comprises ethanolamine.

23. The composition according to claim 3 wherein the acidic component comprises acrylic acid, the component capable of providing a Tg of about −20° C. to 100° C. comprises methyl methacrylate and butyl acrylate, and the amine neutralizing agent comprises ethanolamine.

24. The composition according to claim 1 further comprising at least one surfactant.

25. The composition according to claim 24 wherein the at least one surfactant comprises at least one phosphate surfactant.

26. The composition according to claim 3 further comprising at least one phosphate surfactant.

27. The composition according to claim 26 wherein the amine neutralizing agent comprises ethanolamine.

28. The composition according to claim 3 comprising, based upon total weight of copolymer, about 10 to 80 wt % of said branched neo vinyl ester component, about 0.5 to 5 wt % of said acidic component, up to about 90 wt % of said component capable of providing a copolymer Tg of about −20° C. to 100° C., and an amount of said amine neutralizing agent capable of neutralizing the acidic compound.

29. The composition according to claim 28 comprising, based upon total weight of copolymer about 30 to 60 wt % of said branched neo vinyl ester component, about 0.5 to 1.5 wt % of said acidic component, up to about 70 wt % of said component capable of providing a copolymer Tg of about −20° C. to 100° C., and at least about 0.5 wt % of said amine neutralizing agent capable of neutralizing the acidic compound.

30. The composition according to claim 3 wherein the copolymer comprises particles having a size of about 100 to 1,000 nm.

31. The composition according to claim 30 wherein the copolymer comprises particles having a size of about 100 to 500 nm.

32. A copolymer prepared by polymerizing a branched neo vinyl ester component, an acidic component, and a component capable of providing a Tg of about −20° C. to 100° C. in the presence of at least one surfactant.

33. The copolymer according to claim 32 wherein the at least one surfactant comprises at least one phosphate surfactant.

34. The copolymer according to claim 33 wherein the branched neo vinyl ester component comprises a mixture of neo vinyl esters of the following formula: 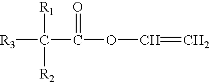
wherein R₁, R₂, and R₃ are independently hydrocarbyl groups, each independently having from 1 to 10 carbon atoms, with R₁+R₂+R₃ having a total average carbon atom content of from 3 to 25 carbon atoms.

35. The copolymer according to claim 34 wherein R₁, R₂, and R₃ are independently alkyl groups, with R₁+R₂+R₃ having a total average carbon content of from 6 to 14 carbon atoms.

36. The copolymer according to claim 35 wherein the total average carbon content of R₁+R₂+R₃ is from 8 to 10 carbon atoms.

37. The copolymer according to claim 34 wherein the acidic component comprises acrylic acid, the component capable of providing a Tg of about −20° C. to 100° C. comprises methyl methacrylate and butyl acrylate, and the amine neutralizing agent comprises ethanolamine.

38. A coating composition comprising the copolymer composition of claim 1.

39. The coating composition according to claim 38 comprising a paint composition.

40. The coating composition according to claim 38 comprising sodium nitrite.

41. A coating composition comprising the copolymer composition of claim 3.

42. A coating composition comprising the copolymer composition of claim 27.

43. A coating composition comprising the copolymer of claim 35.

44. A substrate at least partially coated with the copolymer composition of claim 1.

45. The substrate according to claim 44 wherein the substrate comprises at least one of metal, wood, nonwoven material, concrete, plastic and glass.

46. The substrate according to claim 45 wherein the substrate is metal.

47. The substrate according to claim 46 wherein the substrate is steel.

48. A substrate at least partially coated with the copolymer composition of claim 3.

49. A substrate at least partially coated with the composition of claim 27.

50. A substrate at least partially coated with the copolymer of claim 35.

51. A latex composition comprising (a) copolymer prepared by polymerizing a branched neo vinyl ester component, an acidic component, and a component capable of providing a Tg of about −20° C. to 100° C. in the presence of at least one surfactant in water, and (b) an amine neutralizing agent.

52. The latex composition according to claim 51 wherein the at least one surfactant comprises at least one phosphate surfactant.
